(19) United States
(12) Patent Application Publication
(10) Pub. No.: US 2015/0326618 A1
(43) Pub. Date: Nov. 12, 2015

(54) METHOD OF PROVIDING EVIDENCE COLLECTION TOOL, AND APPARATUS AND METHOD FOR COLLECTING DIGITAL EVIDENCE IN DOMAIN SEPARATION-BASED MOBILE DEVICE

(71) Applicant: ELECTRONICS AND TELECOMMUNICATIONS RESEARCH INSTITUTE, Daejeon (KR)

(72) Inventors: Kyung-Soo LIM, Daejeon (KR); Geon-Lyang Kim, Daejeon (KR); Jeong-Nyeo Kim, Daejeon (KR); Jae-Chan Moon, Daejeon (KR); Su-Wan Park, Daejeon (KR); Jae-Deok Lim, Daejeon (KR)

(73) Assignee: ELECTRONICS AND TELECOMMUNICATIONS RESEARCH INSTITUTE, Daejeon (KR)

(21) Appl. No.: 14/705,155

(22) Filed: May 6, 2015

(30) Foreign Application Priority Data
May 9, 2014 (KR) 10-2014-0055554

(51) Int. Cl. H04L 29/06

(52) U.S. Cl. CPC H04L 63/30; H04L 63/123

(57) ABSTRACT

A method of providing an evidence collection tool, and an apparatus and method for collecting digital evidence in a domain separation-based mobile device are disclosed. The apparatus includes a target device information collection module, a collection module, a transmission module, and a control module. The target device information collection module collects the system feature information and user identification information of a domain separation-based mobile device. The collection module collects digital evidence using a received evidence collection tool. The control module transfers the user identification information and a previously inputted the investigator authentication key value to a server, transfers the security key from the server to the encryption unit of transmission module, the transmission module encrypts the digital evidence using a received security key and transmits the system feature information to the server, and transfers the evidence collection tool from the server to the collection module.

### CROSS-REFERENCE TO RELATED APPLICATION

This application claims the benefit of Korean Patent Application No. 10-2014-0055554, filed May 9, 2014, which is hereby incorporated by reference herein in its entirety.

### BACKGROUND

1. Technical Field

The present disclosure relates generally to a method of providing an evidence collection tool and an apparatus and method for collecting digital evidence in a domain separation-based mobile device and, more particularly, to an apparatus and method that, in order for an investigator to collect digital evidence in the secure domain of a collection target mobile device, install an evidence collection tool corresponding to each domain separation technology from an entrustment server and then collect a user's sensitive information, thereby obtaining digital evidence for conducting forensic investigations of the target device.

2. Description of the Related Art

Recently, the various and convenient functions of smart phones have brought about a rapid growth in the market of mobile phones. Security incidents attributable to attacks, such as an attack of malware, have also increased.

In openness-oriented mobile platforms, security incidents attributable to new types of attacks, such as smishing, have been big issues recently. In order to overcome this vulnerability, domain separation technology that separates a domain from an existing smart phone operating system (OS) and processes a financial transaction or a user's important and sensitive information in a separate security OS has emerged.

When domain separation technology is popularized in the future, it may be impossible to perform the collection of digital evidence in the secure domain of a smart phone which is required for the investigation of an incident using a general forensic investigation procedure. Accordingly, there is a need for a method of collecting digital evidence in the secure domain of a mobile device in which domains have been separated from each other.

Domain separation technology may separate domains into a general domain and a secure (or guest) domain, and may isolate secure domain against unauthorized access for enhancing security. The secure domain store and manage a user's sensitive information, such as a private record, an address book and photos, and mobile banking history used for financial transactions so that these are operated in the secure domain.

Domain separation technology can be divided into a hypervisor-based mobile virtualization technology, a logical domain separation technology, and a hardware chipset-based domain separation technology.

A hypervisor-based mobile virtualization technology is a technology that isolates a plurality of virtual machines generated by single piece of physical mobile equipment and allows communication between the virtual machines to be performed over only an authenticated channel, thereby ensuring a secure execution environment. In this case, different operating systems (OSs) may be installed on the virtual machines.

A logical domain separation technology uses separate an application's access control policies and execution rights based on the each domain in which the application belongs, and allows minimal communication between domains to be performed over only an authenticated channel. Furthermore, an application for each domain is allowed to be downloaded from an app store for the domain, and is then used, respectively.

A hardware chipset-based domain separation technology is an isolation technology that is supported at the level of the processor of a mobile platform, and divides the operating mode of the processor into general mode and secure mode. Furthermore, the hardware chipset-based domain separation technology enables a security application and a general application to be run in two physically separate environments, respectively.

Since the domain separation technologies are various as described above, a domain separation technology and an evidence collection tool corresponding to an OS installed in an isolated secure domain in order to collect digital evidence in the secure domain.

As described above, a mobile device to which a domain separation technology has been applied has a general structure in which a general domain and a secure domain are isolated from each other. Furthermore, in the mobile device to which a domain separation technology has been applied, access based on a digital evidence collection technology used in the general domain cannot be made to the isolated secure domain, and the collection of digital evidence itself may be impossible depending on the operating environment of the secure domain.

As a related technology, Korean Patent Application Publication No. 2009-0064699 entitled “Digital Forensic Server and Method for Evidence Investigation” discloses a technology that provides an environment in which collected digital evidence data can be analyzed all together on a system, and that checks the identity of a person who accesses the system and records an analysis process, thereby providing a secure and reliable digital evidence analysis environment.

### SUMMARY

At least some embodiments of the present invention are directed to the provision of a method of providing an evidence collection tool and an apparatus and method for collecting digital evidence in a domain separation-based mobile device, which enable the collection of digital evidence in the secure domain of a mobile device to which a domain separation technology has been applied.

In accordance with an aspect of the present invention, there is provided a method of providing an evidence collection tool, including: identifying, by a server, the domain separation technology of a domain separation-based mobile device based on system feature information transmitted from the domain separation-based mobile device; selecting, by the server, a corresponding evidence collection tool if the domain separation technology of the domain separation-based mobile device is identified as any one of a hardware chipset-based domain separation technology, a logical domain separation technology, and a hypervisor-based mobile virtualization technology; and transmitting, by the server, the selected evidence collection tool to the domain separation-based mobile device.

Identifying the domain separation technology may include identifying the domain separation technology of the domain separation-based mobile device as the hardware chipset-based domain separation technology based on whether a version capable of changing operating mode in accordance with processor chipset information included in the system feature information and a module capable of supporting the hardware chipset-based domain separation technology have been installed.

Selecting the corresponding evidence collection tool may include selecting a standard API-based evidence collection tool if the domain separation technology of the domain separation-based mobile device is identified as the hardware chipset-based domain separation technology.

Identifying the domain separation technology may include identifying the domain separation technology of the domain separation-based mobile device as the logical domain separation technology based on information about a manufacturer and a mobile device type supporting the logical domain separation technology and information about an installed software supporting the logical domain separation technology, which are included in the system feature information.

Selecting the corresponding evidence collection tool may include selecting an evidence collection tool capable of performing app store collection for each domain if the domain separation technology of the domain separation-based mobile device is identified as the logical domain separation technology.

Identifying the domain separation technology may include identifying the domain separation technology of the domain separation-based mobile device as the hypervisor-based mobile virtualization technology based on information about a kernel module and driver required to be installed in a general domain in order to execute a hypervisor, which is included in the system feature information.

Selecting the corresponding evidence collection tool may include selecting a hypervisor-based evidence collection tool if the domain separation technology of the domain separation-based mobile device is identified as a hypervisor-based mobile virtualization technology.

The method may further include, before identifying the domain separation technology: performing an investigator authentication process for conducting forensic investigation of the target device through communicated with the server; and after the authorized investigator, generating a security key based on user identification information of target device by the server, and transmitting the security key to the domain separation-based mobile device.

In accordance with another aspect of the present invention, there is provided an apparatus for collecting digital evidence in a domain separation-based mobile device, including: a target device information collection module configured to collect target device information including the system feature information and user identification information of a domain separation-based mobile device; a collection module configured to collect analysis requiring digital evidence in the domain separation-based mobile device using a received evidence collection tool; an transmission module configured to encrypt the digital evidence collected by the collection module using a received security key; and a control module configured to transfer the user identification information and a previously inputted the investigator authentication key value to a server, to, after user authentication at the server, receive the security key, generated based on the user identification information, from the server and then transfer the security key to the transmission module, to transmit the system feature information to the server, and to receive the evidence collection tool, selected based on the system feature information and suitable for the domain separation-based mobile device, from the server and then transfer the evidence collection tool to the collection module.

The system feature information may include information about a manufacturer, an operating system (OS) platform and version and a processor chipset type, kernel-related information, and installed software information.

The user identification information may include user personal information and a target device manufacture serial number.

The transmission module may be further configured to, when the digital evidence collected by the collection module can be stored in a separate storage device, encrypt the digital evidence and then store the encrypted digital evidence in the separate storage device.

The transmission module may be further configured to, when the digital evidence collected by the collection module cannot be stored in a separate storage device, encrypt the digital evidence and then transfer the encrypted digital evidence to the server.

The evidence collection tool may include: a collection module including a filesystem analysis unit configured to collect a particular file related information such as file record, metadata, timestamps and others as the digital evidence by analyzing the meta information of the filesystem of the separate secure domain of the domain separation-based mobile device; a control module including a digital evidence metadata generation unit configured to generate the metadata of the digital evidence; and a transmission module including a data encryption unit configured to encrypt the digital evidence based on the security key of the domain separation-based mobile device issued by the server.

The collection module may further include: a file duplication unit configured to collect an identical file corresponding to an original file by performing duplicating physical file data allocation (such as clusters, pages, etc), in which the data of the file has been stored, based on metadata of the filesystem; a memory dump unit configured to provide a memory dump function when the memory analysis, used in secure domain of the domain separation-based mobile device, is required; and a deleted file recovery unit configured to recover a deleted file based on the filesystem metadata of the deleted file based on a processing result of the filesystem analysis unit.

The control module may further include: a log management unit configured to generate and manage a log regarding information on which a digital evidence collection function has been performed; and an integrity verification unit configured to calculate and compare the cryptographic hash values between the collected file and the original file to determine whether they match each other.

The transmission module may further include: an authentication management unit configured to provide a management function for user authentication and session maintenance upon transmitting information to the server over a network.

In accordance with still another aspect of the present invention, there is provided a method of collecting digital evidence in a domain separation-based mobile device, including: collecting, by a target device information collection module, the user identification information and system feature information of a domain separation-based mobile device; transferring, by a control module, the user identification information and a previously inputted the investigator authentication key value to a server; receiving, by the control module, a security key, generated based on the user identification information, from the server after user authentication at the server; transmitting, by the control module, the system feature information to the server; receiving, by the control module, an evidence collection tool, selected based on the system feature information and suitable for the domain separation-based mobile device, from the server; collecting, by a collection module, analysis requiring digital evidence in the domain separation-based mobile device using the evidence collection tool; and encrypting, by an transmission module, the collected digital evidence using the security key.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic diagram illustrating the collection of digital evidence in a domain separation-based mobile device according to an embodiment of the present invention;

FIG. 2 is a configuration diagram illustrating an apparatus for collecting digital evidence in a domain separation-based mobile device according to an embodiment of the present invention;

FIG. 3 is a configuration diagram illustrating an evidence collection tool that is applied to an embodiment of the present invention;

FIG. 4 is a flowchart illustrating a method of collecting digital evidence in a domain separation-based mobile device according to an embodiment of the present invention; and

FIG. 5 is a detailed flowchart illustrating the step of identifying a domain separation technology and selecting a suitable evidence collection tool, which is illustrated in FIG. 4.

### DETAILED DESCRIPTION

The present invention may be subjected to various modifications and have various embodiments. Specific embodiments are illustrated in the drawings and described in detail below.

However, it should be understood that the present invention is not intended to be limited to these specific embodiments but is intended to encompass all modifications, equivalents and substitutions that fall within the technical spirit and scope of the present invention.

The terms used herein are used merely to describe embodiments, and not to limit the inventive concept. A singular form may include a plural form, unless otherwise defined. The terms, including “comprise,” “includes,” “comprising,” “including” and their derivatives specify the presence of described shapes, numbers, steps, operations, elements, parts, and/or groups thereof, and do not exclude presence or addition of at least one other shapes, numbers, steps, operations, elements, parts, and/or groups thereof.

Unless otherwise defined herein, all terms including technical or scientific terms used herein have the same meanings as commonly understood by those skilled in the art to which the present invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

Embodiments of the present invention are described in greater detail below with reference to the accompanying drawings. In order to facilitate the general understanding of the present invention, like reference numerals are assigned to like components throughout the drawings and redundant descriptions of the like components are omitted.

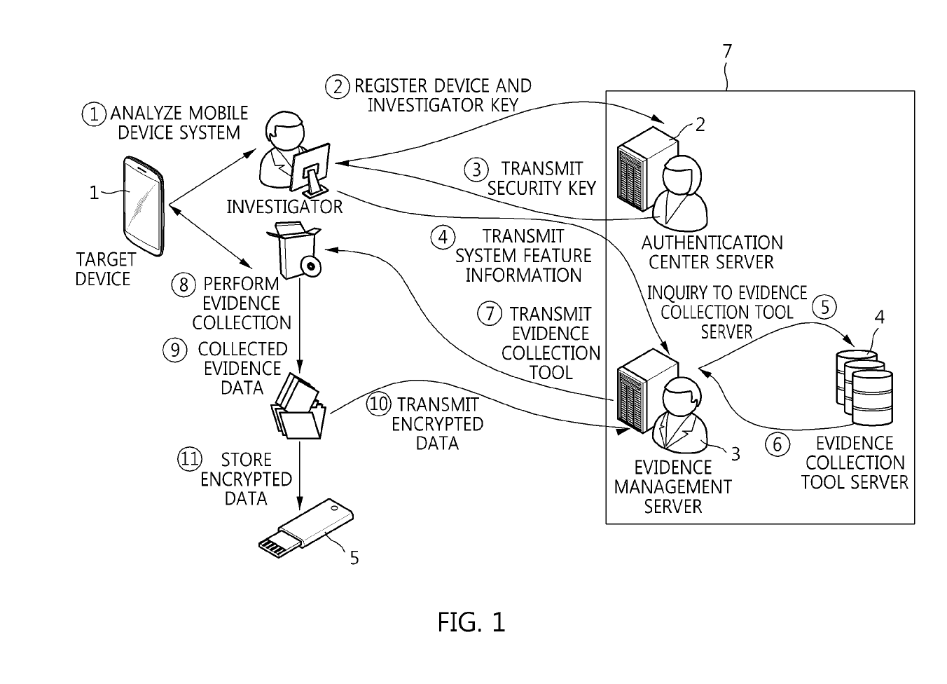

FIG. 1 is a schematic diagram illustrating the collection of digital evidence in a domain separation-based mobile device according to an embodiment of the present invention. In FIG. 1, reference numeral 7 denotes a server. The server 7 includes an authentication center server 2, an evidence management server 3, and an evidence collection tool server 4.

An investigator who has secured an target mobile device 1 collects various pieces of information about the corresponding device 1 by analyzing the corresponding device 1 (\textcircled{1}). In this case, the various pieces of information include system feature information and user identification information. In this case, the system feature information may include the model of the corresponding device 1, OS information, system information, and the type of domain separation technology. The user identification information may refer to unique information, such as the name of a user, a telephone number, and a manufacture serial number.

Thereafter, the investigator transfers user identification information and the investigator authentication key value to the authentication center server 2 within the server 7 (\textcircled{2}).

Accordingly, the authentication center server 2 transmits a security key, generated based on the user identification information of the corresponding device 1, to the corresponding device 1 after authenticating the investigator (\textcircled{3}).

The investigator uses the transmitted security key to perform encryption for the secure storage of the collected digital evidence in the future.

The investigator transmits the system feature information of the investigation target mobile device 1 to the evidence management server 3 of the server 7 (\textcircled{4}).

The evidence management server 3 makes an inquiry to the evidence collection tool server 4 based on the system feature information of the corresponding device 1 (\textcircled{5}), and generates and transmits an evidence collection tool suitable for the corresponding device 1 (\textcircled{6}) and (\textcircled{7}).

Accordingly, the investigator collects data using the received evidence collection tool (\textcircled{8}) and (\textcircled{9}), and encrypts the collected data using the security key received at an initial authentication step.

The collected data encrypted as described above is transferred to the evidence management server 3 over a network and then stored therein (\textcircled{10}), or is stored in a separate digital evidence storage device 5 (e.g., USB memory) (\textcircled{11}).

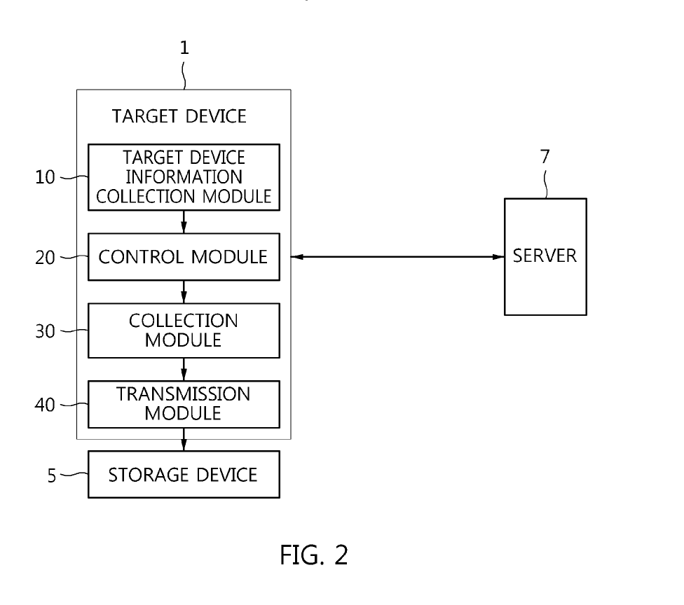

Although the investigator has been illustrated as collecting system feature information and user identification information regarding the corresponding device 1 by analyzing the corresponding device 1, transferring the user identification information and the investigator authentication key to the server 7, and collecting data using an evidence collection tool transmitted from the server 7 in FIG. 1, this illustration has been given merely for ease of illustration, and these operations can be sufficiently performed by the internal configuration (see FIG. 2) of the corresponding domain separation-based mobile device 1, other than the investigator.

FIG. 2 is a configuration diagram illustrating an apparatus for collecting digital evidence in a domain separation-based mobile device according to an embodiment of the present invention. The apparatus for collecting digital evidence illustrated in FIG. 2 may be installed in the domain separation-based mobile device 1.

The apparatus for collecting digital evidence includes a target device information collection module 10, a control module 20, a collection module 30, and a transmission module 40.

The target device information collection module 10 collects the target device information (i.e., system feature information, user identification information) of the corresponding domain separation-based mobile device 1. The target device information collection module 10 transfers the collected target device information to the control module 20.

The control module 20 temporarily stores the target device information (i.e., system feature information, and user identification information) transmitted from the target device information collection module 10, and then transfers the user identification information and the previously inputted investigator authentication key value to the authentication center server 2 of the server 7. In this case, the authentication center server 2 performs investigator authentication, generates a security key based on the user identification information of the corresponding domain separation-based mobile device 1, and transmits the security key to the corresponding domain separation-based mobile device 1. The control module 20 receives and stores the security key, and provides the security key when the transmission module 40 performs encryption later.

Meanwhile, the control module 20 transfers the system feature information of the corresponding domain separation-based mobile device 1 to the evidence management server 3 of the server 7. In this case, the evidence management server 3 of the server 7 makes an inquiry to the evidence collection tool server 4 based on the received system feature information, and the evidence collection tool server 4 generates an evidence collection tool suitable for the corresponding domain separation-based mobile device 1, and transfers the evidence collection tool to the evidence management server 3. As a result, the evidence management server 3 transmits the received evidence collection tool to the corresponding domain separation-based mobile device 1.

Furthermore, the control module 20 transfers the received evidence collection tool suitable for the corresponding domain separation-based mobile device 1 to the collection module 30.

The collection module 30 may collect digital evidence (i.e., a file and related data) for requiring forensic analysis in the corresponding domain separation-based mobile device 1 using the received evidence collection tool. The collection module 30 transfers the collected digital evidence to the transmission module 40.

The transmission module 40 may encrypt the received digital evidence using the security key, which is received from the control module 20, and may transmit the encrypted digital evidence to the separate storage device 5 or the evidence management server 3 of the server 7. In this case, when it is possible to store the digital evidence from the corresponding domain separation-based mobile device 1 to the separate storage device 5, the transmission module 40 encrypts the collected digital evidence and then stores the encrypted digital evidence in the separate storage device 5. In contrast, when it is impossible to store the digital evidence from the corresponding domain separation-based mobile device 1 to the separate storage device 5, the transmission module 40 encrypts the collected digital evidence and then transfers the encrypted collected digital evidence to the server 7 of the evidence management server 3.

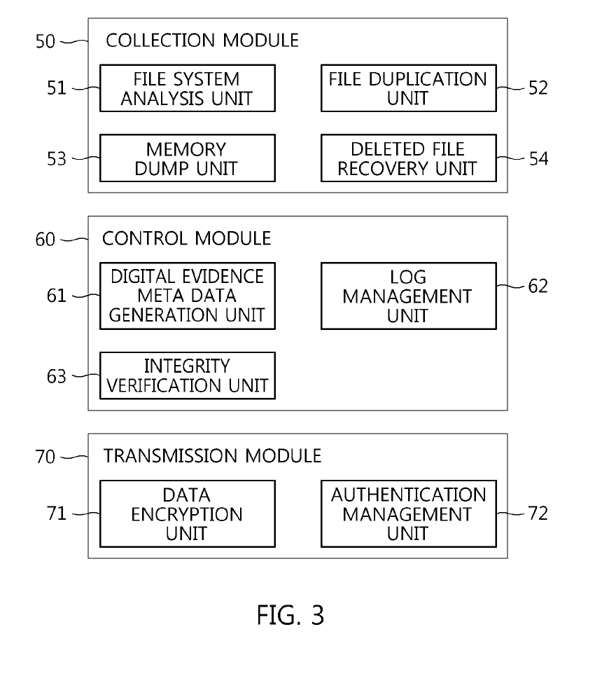

FIG. 3 is a configuration diagram illustrating an evidence collection tool that is applied to an embodiment of the present invention.

The evidence collection tool illustrated in FIG. 3 includes a collection module 50, a control module 60, and a transmission module 70.

The collection module 50 includes a filesystem analysis unit 51, a file duplication unit 52, a memory dump unit 53, and a deleted file recovery unit 54. The filesystem analysis unit 51 acquires a file record and metadata as digital evidence by analyzing the metadata information of the filesystem of the separate secure domain of the corresponding domain separation-based mobile device 1. The file duplication unit 52 collect an identical file corresponding to an original file by performing duplicating physical file data allocation (such as clusters, pages, etc), in which the data of the file has been stored, based on metadata of the filesystem because integrity may be damaged by simple file copying in the focus of digital forensics. The memory dump unit configured to provide a memory dump function when the memory analysis, used in secure domain of the domain separation-based mobile device 1, is required. The deleted file recovery unit 54 recover a deleted file using filesystem metadata of the deleted file which is based on the result of the filesystem analysis unit 51.

The control module 60 includes a digital evidence metadata generation unit 61, a log management unit 62, and an integrity verification unit 63. The digital evidence metadata generation unit 61 generates the metadata of the collected digital evidence. That is, the digital evidence metadata generation unit 21 generates and manages important metadata, such as the path, size and time information of the collected digital evidence file. The log management unit 62 generates and manages a log regarding information on which a digital evidence collection function has been performed. The integrity verification unit 63 provides the function of calculating and comparing the cryptographic hash values between the collected file and the original file to determine whether they match each other.

The transmission module 70 includes a data encryption unit 71 and an authentication management unit 72. The data encryption unit 71 and the authentication management unit 72. The data encryption unit 71 performs the function of encrypting collected digital evidence (evidential data, evidential file, and/or the like) based on an security key issued by the authentication center server 2 and unique to the target device. The authentication management unit 72 provides a management function for the authentication of an investigator and the maintenance of a session upon transmission the remote evidence management server 3 over a network.

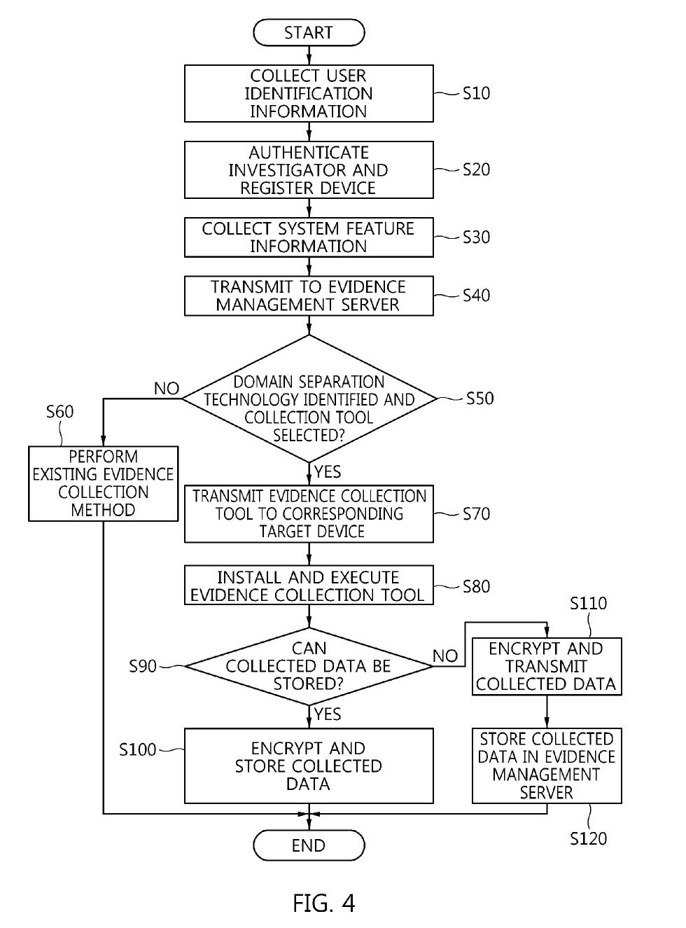

FIG. 4 is a flowchart illustrating a method of collecting digital evidence in a domain separation-based mobile device according to an embodiment of the present invention.

First, the target device information collection module 10 of the domain separation-based mobile device 1, i.e., a target device for conducting forensic investigation, collects user identification information (e.g., user personal information (a user name, a telephone number, and a communication service provider), a target device manufacture serial number, etc.) by analyzing the corresponding domain separation-based mobile device 1 at step S10. The target device information collection module 10 transfers the collected user identification information to the control module 20.

Thereafter, at step S20, the control module 20 transfers the investigator authentication key value and received user identification information of the corresponding domain separation-based mobile device 1 to the authentication center server 2 of the server 7 over a network (not illustrated) in order to allow the investigator authentication and the target device registration to be performed.

Accordingly, the authentication center server 2 of the server 7 authenticates the investigator, and then transfers a security generated based on the user identification information of the corresponding device to the corresponding domain separation-based mobile device 1 over a network (not illustrated). In this case, the control module 20 of the corresponding domain separation-based mobile device 1 receives and stores the security key.

Thereafter, at step S30, the target device information collection module 10 collects the system feature information (for example, a manufacturer, an OS platform and version, a processor chipset type, kernel-related information, installed software information, etc.) of the corresponding domain separation-based mobile device 1 under the control of the control module 20. The target device information collection module 10 transfers the collected system feature information to the control module 20.

Thereafter, the control module 20 transmits the received system feature information to the evidence management server 3 of the server 7 over a network (not illustrated) at step S40.

Accordingly, the evidence management server 3 of the server 7 starts analysis based on the received system feature information at step S50. In this case, the term “analysis” refers to identifying a domain separation technology applicable to the corresponding domain separation-based mobile device 1 based on the system feature information, determining whether the technology has been actually applied, and selecting a suitable evidence collection tool. For example, a hardware chipset-based domain separation technology may be identified by determining whether a version capable of changing operating mode in accordance with a processor chipset and a module capable of supporting the hardware chipset-based domain separation technology has been installed. For example, a logical domain separation technology may be identified based on information about a manufacturer and mobile device type capable of supporting the logical domain separation technology and information about installed software capable of supporting the logical domain separation technology. For example, a hypervisor-based mobile virtualization technology may be identified based on information about a kernel module and driver required to be installed in a general domain in order to execute a hypervisor.

If, as a result of the analysis, it is impossible to identify a domain separation technology applicable to the corresponding domain separation-based mobile device 1 and select a suitable evidence collection tool (“NO” at step S50), a general existing method of digital evidence collection is performed at step S60.

In contrast, if, as a result of the analysis, a domain separation technology applicable to the corresponding domain separation-based mobile device 1 is identified and a suitable evidence collection tool is selected (“YES” at step S50), the evidence management server 3 of the server 7 transfers the selected evidence collection tool to the corresponding domain separation-based mobile device 1 over a network (not illustrated) at step S70.

Accordingly, the control module 20 of the corresponding domain separation-based mobile device 1 transfers the received evidence collection tool to the collection module 30.

The collection module 30 collects files and related data for conducting forensic investigation using the evidence collection tool at step S80. In this case, the collection module 30 transfers the collected data to the transmission module 40.

Thereafter, if the collected data can be stored from the corresponding domain separation-based target mobile device 1 to the separate storage device 5 (“YES” at step S90), the transmission module 40 receives a security key from the control module 20, encrypts the data using the security key, and stores the encrypted data in the separate storage device 5 at step S100.

In contrast, if the collected data cannot be stored from the corresponding domain separation-based mobile device 1 to the separate storage device 5 (“NO” at step S90), the transmission module 40 receives a security key from the control module 20, encrypts the data using the security key, and transmits the encrypted data to the evidence management server 3 of the server 7 over a network (not illustrated) at step S110.

Accordingly, the evidence management server 3 of the server 7 stores the received collected data at step S120.

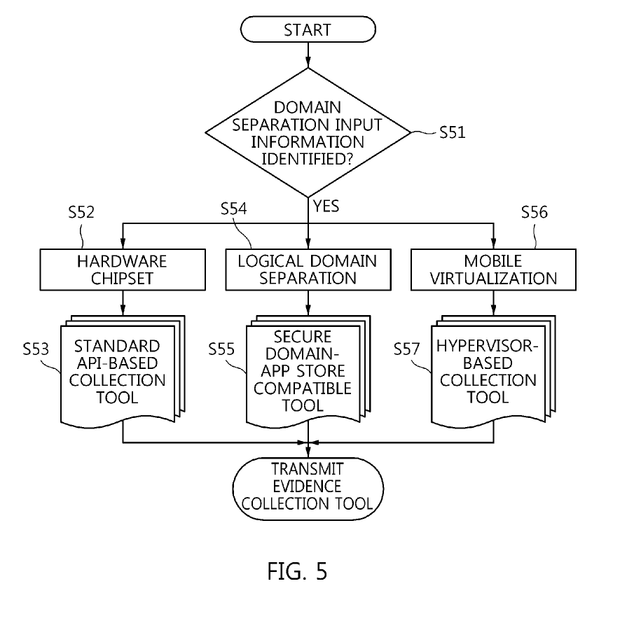

FIG. 5 is a flowchart illustrating step S50 of identifying a domain isolation technology and selecting a suitable evidence collection tool, which is illustrated in FIG. 4. The evidence management server 3 of the server 7 provides the function of identifying a domain separation technology applied to the investigation target mobile device 1 and also selects an evidence collection tool based on received system feature information, and then transmits the selected evidence collection tool to the corresponding investigation target mobile device 1.

In step S50 of identifying a domain separation technology and selecting a suitable evidence collection tool, the domain separation technology of the corresponding domain separation-based mobile device 1 is identified by detecting the type of domain separation technology from the system feature information at initial domain separation input information checking step S51. In this case, a method of identifying the domain separation technology of the corresponding domain separation-based mobile device 1 may follow the method set forth in the description of FIG. 4.

For example, if, as a result of the determination at step S51, the domain separation technology of the corresponding domain separation-based mobile device 1 is a hardware chipset-based domain separation technology at step S52, a standard API-based evidence collection tool is selected at step S53. In this case, the hardware chipset-based domain separation technology supports a standard API, via which access to and collection of a file of a secure domain are enabled.

Meanwhile, for example, if, as a result of the determination at step S51, the domain separation technology of the corresponding domain separation-based mobile device 1 is a logical domain separation technology at step S54, an evidence collection tool capable of performing data collection by download and installation from app store for each domain is selected at step S55. In this case, since the logical domain separation environment provides an app store executable only in a secure domain, an evidence collection tool that is accessible to only the corresponding domain separation-based mobile device may be downloaded using the feature of the logical domain separation environment, and then file access and collection may be performed using the downloaded tool.

Meanwhile, for example, if, as a result of the determination at step S51, the domain separation technology of the corresponding domain separation-based mobile device 1 is a hypervisor-based mobile virtualization technology at step S56, a hypervisor-based evidence collection tool is selected at step S57. In this case, since the hypervisor-based evidence collection tool provides various collection methods with respect to respective hypervisors, access to and collection of a file in the secure domain may be collected using a domain communication driver based on the type of hypervisor.

The present invention provides the advantage of analyzing a domain separation technology based on the system feature information and user identification information of a device, allowing an evidence collection tool to be downloaded from a server, and enabling investigation.

Furthermore, the present invention provides the advantage of encrypting collected digital evidence data based on an security key generated from the information of a target mobile device, thereby preventing malicious divulgement and damage.

Furthermore, the present invention provides the advantage of entrusting collected digital evidence to a server when the collected digital evidence cannot be stored in a storage medium connectable to a mobile device.

As described above, the optimum embodiments have been disclosed in the drawings and the specification. Although specific terms have been used herein, they have been used merely for the purpose of describing the present invention, but have not been used to restrict their meanings or limit the scope of the present invention set forth in the claims. Accordingly, it will be understood by those having ordinary knowledge in the relevant technical field that various modifications and other equivalent embodiments can be made. Therefore, the true range of protection of the present invention should be defined based on the technical spirit of the attached claims.

What is claimed is:

1. A method of providing an evidence collection tool, comprising:
identifying, by a server, a domain separation technology of a domain separation-based mobile device based on system feature information transmitted from the domain separation-based mobile device;
selecting, by the server, a corresponding evidence collection tool if the domain separation technology of the domain separation-based mobile device is identified as any one of a hardware chipset-based domain separation technology, a logical domain separation technology, and a hypervisor-based mobile virtualization technology; and
transmitting, by the server, the selected evidence collection tool to the domain separation-based mobile device.

2. The method of claim 1, wherein identifying the domain separation technology comprises identifying the domain separation technology of the domain separation-based mobile device as the hardware chipset-based domain separation technology based on whether a version capable of changing operating mode in accordance with processor chipset information included in the system feature information and a module capable of supporting the hardware chipset-based domain separation technology have been installed.

3. The method of claim 1, wherein selecting the corresponding evidence collection tool comprises selecting a standard API-based evidence collection tool if the domain separation technology of the domain separation-based mobile device is identified as the hardware chipset-based domain separation technology.

4. The method of claim 1, wherein identifying the domain separation technology comprises identifying the domain separation technology of the domain separation-based mobile device as the logical domain separation technology based on information about a manufacturer and a mobile device type supporting the logical domain separation technology and information about an installed software supporting the logical domain separation technology, which are included in the system feature information.

5. The method of claim 1, wherein selecting the corresponding evidence collection tool comprises selecting an evidence collection tool capable of performing app store collection for each domain if the domain separation technology of the domain separation-based mobile device is identified as the logical domain separation technology.

6. The method of claim 1, wherein identifying the domain separation technology comprises identifying the domain separation technology of the domain separation-based mobile device as the hypervisor-based mobile virtualization technology based on information about a kernel module and driver required to be installed in a general domain in order to execute a hypervisor, which is included in the system feature information.

7. The method of claim 1, wherein selecting the corresponding evidence collection tool comprises selecting a hypervisor-based evidence collection tool if the domain separation technology of the domain separation-based mobile device is identified as a hypervisor-based mobile virtualization technology.

8. The method of claim 1, further comprising, before identifying the domain separation technology:
performing user authentication of the domain separation-based mobile device; and
after the user authentication, generating a security key based on user identification information transmitted from the domain separation-based mobile device, and transmitting the security key to the domain separation-based mobile device.

9. An apparatus for collecting digital evidence in a domain separation-based mobile device, comprising:
a target device information collection module configured to collect target device information including system feature information and user identification information of a domain separation-based mobile device;
a collection module configured to collect digital evidence for conducting forensic investigation in the domain separation-based mobile device using a received evidence collection tool;
an transmission module configured to encrypt the digital evidence collected by the collection module using a received security key; and
a control module configured to transfer the user identification information and a previously inputted the investigator authentication key value to a server, to, after authorization at the server, receive the security key, generated based on the user identification information, from the server and then transfer the security key to the transmission module, to transmit the system feature information to the server, and to receive the evidence collection tool, selected based on the system feature information and suitable for the domain separation-based mobile device, from the server and then transfer the evidence collection tool to the collection module.

10. The apparatus of claim 9, wherein the system feature information comprises information about a manufacturer, an operating system (OS) platform and version and a processor chipset type, kernel-related information, and installed software information.

11. The apparatus of claim 9, wherein the user identification information comprises user personal information and a target device manufacture serial number.

12. The apparatus of claim 9, wherein the transmission module is further configured to, when the digital evidence collected by the collection module can be stored in a separate storage device, encrypt the digital evidence and then store the encrypted digital evidence in the separate storage device.

13. The apparatus of claim 9, wherein the transmission module is further configured to, when the digital evidence collected by the collection module cannot be stored in a separate storage device, encrypt the digital evidence and then transfer the encrypted digital evidence to the server.

14. The apparatus of claim 9, wherein the evidence collection tool comprises:
a collection module including a filesystem analysis unit configured to collect a file record, metadata and other file-related filesystem information as the digital evidence by analyzing meta information of a filesystem of a separate secure domain of the domain separation-based mobile device;
a control module including a digital evidence metadata generation unit configured to generate metadata of the digital evidence; and
a transmission module including a data encryption unit configured to encrypt the digital evidence based on the security key of the domain separation-based mobile device issued by the server.

15. The apparatus of claim 14, wherein the collection module further comprises:
a file duplication unit configured to collect an identical file corresponding to an original file by performing duplicating physical file data, in which the data of the file has been stored, based on metadata of the filesystem;
a memory dump unit configured to provide a memory dump unit configured to provide a memory dump function when the memory analysis, used in secure domain of the domain separation-based mobile device, is required; and
a deleted file recovery unit configured to recover a deleted file based on metadata of the deleted file based on a processing result of the filesystem analysis unit.

16. The apparatus of claim 14, wherein the control module further comprises:
a log management unit configured to generate and manage a log regarding information on which a digital evidence collection function has been performed; and
an integrity verification unit configured to calculate cryptographic hash values of a collected file and an original and determine whether they match each other.

17. The apparatus of claim 14, wherein the transmission module further comprises:
an authentication management unit configured to provide a management function for user authentication and session maintenance upon transmitting information to the server over a network.

18. A method of collecting digital evidence in a domain separation-based mobile device, comprising:
collecting, by a target device information collection module, user identification information and system feature information of a domain separation-based mobile device;
transferring, by a control module, the user identification information and a previously inputted the investigator authentication key value to a server;
receiving, by the control module, a security key, generated based on the user identification information, from the server after user authentication at the server;
transmitting, by the control module, the system feature information to the server;
receiving, by the control module, an evidence collection tool, selected based on the system feature information and suitable for the domain separation-based mobile device, from the server;
collecting, by a collection module, analysis requiring digital evidence in the domain separation-based mobile device using the evidence collection tool; and
encrypting, by an transmission module, the collected digital evidence using the security key.

19. The method of claim 18, wherein encrypting the collected digital evidence comprises, when the collected digital evidence can be stored in a separate storage device, encrypting the collected digital evidence and then storing the encrypted digital evidence in the separate storage device.

20. The method of claim 18, wherein encrypting the collected digital evidence comprises, when the collected digital evidence cannot be stored in a separate storage device, encrypting the digital evidence and then transferring the encrypted digital evidence to the server.
